(19) United States
(12) Patent Application Publication
(10) Pub. No.: US 2026/0208144 A1
(43) Pub. Date: Jul. 23, 2026

(54) METHOD AND APPARATUS FOR SYNTHESIS REACTION BETWEEN REAGENT AND PACKING

(71) Applicant: INSCINSTECH CO, LTD, Suzhou (CN)

(72) Inventors: Dawei LI, Suzhou (CN); Guoqi LI, Suzhou (CN); Guoan HE, Suzhou (CN)

(21) Appl. No.: 19/569,288

(22) Filed: Mar. 17, 2026

Related U.S. Application Data
(63) Continuation of application No. PCT/CN2025/114021, filed on Aug. 12, 2025.

(30) Foreign Application Priority Data
Jan. 22, 2025 (CN) 202510097045.3

(51) Int. Cl. B01J 19/00; B01J 4/00

(52) U.S. Cl. CPC B01J 19/0046; B01J 4/002; B01J 2219/0004; B01J 2219/00189; B01J 2219/0036

(57) ABSTRACT

The disclosure provides a method and apparatus for a synthesis reaction between a reagent and a packing, the method comprising: S1, introducing a preset volume of a reagent liquid into a synthesis vessel; S2, allowing a part of a preset volume of the reagent liquid to flow through the reaction packing to obtain a primary reaction fluid; S3, allowing a part of a preset volume of the primary reaction fluid to flow through the reaction packing again in a reverse direction to obtain a secondary reaction fluid, wherein the other part of the primary reaction fluid that does not flow through the reaction packing in a reverse direction becomes a discharged liquid separated from the reaction packing; and S4, after repeating S2 to S3 multiple times, discharging the reagent liquid remaining in the synthesis vessel. The disclosure enables complete conversion of residual liquids, thereby achieving cost reduction and environmental protection.

### TECHNICAL FIELD

The disclosure relates to the technical field of synthesis, and in particular to a method and apparatus for a synthesis reaction between a reagent and a packing.

### BACKGROUD

In the fields of chemical synthesis and biotechnology, numerous chemical reactions and processes are involved, in which a wide variety of chemical reagents and packings (synthetic supports) are extensively utilized. These processes typically involve injecting specific chemical reagents into a reaction vessel by a liquid injection unit to react chemically with the packings or other reactants in the vessel. However, the existing technical solutions have certain limitations in terms of reagent utilization and residual liquid disposal.

In the prior art, the processes of chemical reagent injection and residual liquid discharge are typically non-selective. That is, during the chemical reaction, both the reagents that have participated in the reaction and the unreacted reagents are discharged together, as illustrated in the structure in FIG. 1. Taking nucleic acid synthesis technology as an example, the existing nucleic acid synthesis technology generally adopts a column-based synthesis method (referring to FIG. 1). This method involves injecting key chemical reagents such as A/G/C/T monomer reagents corresponding to four different bases, and acetonitrile into a synthesis vessel by a liquid injection unit to facilitate the chemical reactions between the reagents and the coupling sites on the solid-phase carrier packings within the synthesis vessel, thereby progressively constructing the target nucleic acid sequence. However, during this process, the chemical reagents injected into the synthesis vessel are directly discharged through a liquid discharge line, regardless of whether they have completely reacted.

This disposal approach leads to several notable problems: first, the utilization rate of the chemical reagents is generally low, because unreacted reagents are discharged together with the residual liquids and cannot be effectively utilized in the current or subsequent synthesis process. Second, the purity of the synthesized product is affected, and the presence of these components reduces the purity of the final product. Third, the overall synthesis cost is high. Due to the waste of reagents and the problem of product purity, more reagents and subsequent purification steps are required in the synthesis process, thereby increasing the cost.

Specifically, the reasons for the reduced purity of the synthesized product are as follows. Each time any of the A/G/C/T reagents is introduced into the synthesis vessel, the reagent introduced each time is coupled to a coupling site on the packing in the synthesis vessel by a synthesis reaction. There are numerous coupling sites (hereinafter referred to as units) on the packing in the synthesis vessel. It is assumed that during the injection of an A monomer reagent, two of the units (assumed to be named as X unit and Y unit) in the packing are selected, wherein the X unit reacts with the A reagent, and the Y unit does not react with A. Subsequently, a G reagent, a C reagent and a T reagent are continuously introduced, and both the X unit and the Y unit react with each of the G reagent, C reagent and T reagent. As a result, two products are synthesized, i.e., a product 1 synthesized on the X unit having a sequence AGCT, and a product 2 synthesized on the Y unit having a sequence GCT. For the above reasons, conventional synthetic techniques reduce the utilization rate of chemical reagents and the purity of the final nucleic acid product, thus limiting the application and development of the synthetic techniques in a wider range of fields to some extent.

Therefore, one of the technical problems to be solved by the disclosure is how to improve product purity, i.e., how to synthesize a product with a desired base sequence on each packing unit.

### SUMMARY

Therefore, the technical problem to be solved by the disclosure is to overcome the problems of low reagent utilization rates, low product purity, and high synthesis cost in the prior art, and to provide a new method and apparatus for a synthesis reaction between a reagent and a packing.

In order to solve the above technical problems, the disclosure provides a method for a synthesis reaction between a reagent and a packing, the method comprising: step S1, providing a reagent liquid comprising the reagent, and a synthesis vessel loaded with a reaction packing, and introducing a first preset volume of the reagent liquid into the synthesis vessel; step S2, allowing a part of a second preset volume of the reagent liquid to flow through the reaction packing to obtain a primary reaction fluid; step S3, allowing a part of a third preset volume of the primary reaction fluid to flow through the reaction packing again in a reverse direction to obtain a secondary reaction fluid, wherein the other part of the primary reaction fluid that does not flow through the reaction packing in a reverse direction is separated from the reaction packing as a discharged liquid, and a fourth volume of the discharged liquid is the difference between the second volume and the third volume; and In step S4, after repeating steps S2-S3 multiple times, the reagent liquid remaining in the synthesis vessel is discharged.

In an embodiment of the present disclosure, the first volume of the reaction liquid introduced into the synthesis vessel in step S1 is designated as V1, and step S2 further comprises: defining the second volume of the primary reaction fluid as V2, and deriving a value of V2 by the following relationship: V2 = X • V1/n, where n is an integer greater than 1, and 1 < X < n.

In an embodiment of the disclosure, in step S3, step S3 further comprises: defining the third volume of the secondary reaction fluid as V3, and deriving a value of V3 by the following relationship: V3 = (X-1) • V1/n, defining the volume of the discharged liquid exiting the reaction packing as V4, and V4 = V2 - V3 = V1/n.

In an embodiment of the disclosure, in step S4, the number of repetitions of steps S2 to S3 depends on the values of n and X, and is positively correlated with the value of n and negatively correlated with the value of X.

In an embodiment of the disclosure, in step S4, the number of maximum repetitions of steps S2 to S3 is an integer obtained by rounding down a calculation result of (n-X+1).

In an embodiment of the disclosure, in step S2, the part of the reagent liquid flows through the reaction packing at a first velocity Vx in a range of 5-100 μl/s; and in step S3, the part of the primary reaction fluid flows through the reaction packing again in the reverse direction at a second velocity Vy in a range of 5-100 μl/s.

In an embodiment of the disclosure, in step S2, the part of the reagent liquid flows through the reaction packing and remains still for a first time T1 to obtain the primary reaction fluid; and in step S3, the part of the primary reaction fluid flows through the reaction packing again in the reverse direction and remains still for a second time T2 to obtain the secondary reaction fluid.

The disclosure further provides an apparatus for synthesis of a reagent and a packing, the apparatus comprising: a liquid injection unit, a synthesis vessel, and a liquid driving unit, wherein the liquid injection unit is connected to a storage vessel storing a reagent liquid containing the reagent, the synthesis vessel is loaded with a reaction packing, and the liquid injection unit is configured to introduce the reagent liquid into the synthesis vessel; the liquid driving unit is in communication with the synthesis vessel and is configured to control the flow and a flow direction of the reagent liquid in the synthesis vessel; and the apparatus for synthesis of a reagent and a packing performs the synthesis of the reagent with the packing by

step a, introducing a first preset volume of the reagent liquid into the synthesis vessel by the liquid injection unit;

step b, allowing a part of a second preset volume of the reagent liquid to flow through the reaction packing by the liquid driving unit to obtain a primary reaction fluid;

step c, allowing a part of a third preset volume of the primary reaction fluid to flow through the reaction packing again in a reverse direction by the liquid driving unit to obtain a secondary reaction fluid, wherein the other part of the primary reaction fluid that does not flow through the reaction packing in a reverse direction is separable from the reaction packing as a discharged liquid, and a fourth volume of the discharged liquid is the difference between the second volume and the third volume; and

step d, after repeating steps b and c multiple times by the liquid driving unit, discharging the reagent liquid remaining in the synthesis vessel.

In an embodiment of the disclosure, the apparatus for synthesis of a reagent and a packing comprises a plurality of liquid injection units, a plurality of synthesis vessels, and a plurality of liquid driving units, wherein the plurality of liquid injection units are arranged in a one-to-one correspondence with the plurality of synthesis vessels, and any of the synthesis vessels is in communication with one of the liquid driving units.

In an embodiment of the disclosure, the liquid driving unit comprises a pump and two interface nozzles each provided on the pump, wherein one of the interface nozzles is in communication with the synthesis vessel, and the other of the interface nozzles is in communication with a discharged liquid collection device.

In an embodiment of the disclosure, the apparatus for synthesis of a reagent and a packing further comprises a control mechanism configured to control the operations of the liquid injection units and the liquid driving units in steps a to d.

In an embodiment of the present disclosure, the first volume of the reaction liquid introduced into the synthesis vessel in step a is defined as V1; step b further comprises: defining the second volume of the primary reaction fluid as V2, and deriving a value of V2 by the following relationship: V2 = X • V1/n, where n is an integer greater than 1, and 1 < X < n; step c further comprises: defining the third volume of the secondary reaction fluid as V3, and deriving the value of V3 by the following relationship: V3 = (X-1) • V1/n; defining the fourth volume of the discharged liquid separated from the reaction packing as V4, and V4 = V2 - V3 = V1/n; and the values of V1, n, and X are set by a user by means of the control mechanism.

Compared with the prior art, the above technical solutions of the disclosure have the following advantages:

The method and apparatus for a synthesis reaction between a reagent and a packing according to the present disclosure achieve the complete conversion processing of residual liquids by increasing the number of contacts between the reaction liquid and the packing to enable the two to sufficiently contact and react. Therefore, the disclosure not only improves the utilization rate of the reagent, thereby achieving the purpose of cost reduction and environmental protection, but also significantly improves the purity of the product. Compared with existing conventional processing techniques, the present application possesses advantages such as high controllability over reaction processes, complete mixing and conversion effects, reduced reagent waste, and improved product quality, providing a new approach for the synthesis of a reagent and a packing.

### BRIEF DESCRIPTION OF THE DRAWINGS

In order to make the contents of the disclosure more easily understood, the disclosure will be explained in further detail below according to specific embodiments of the disclosure and with reference to the accompanying drawings.

FIG. 1 shows a schematic structural diagram of a conventional synthesis apparatus;

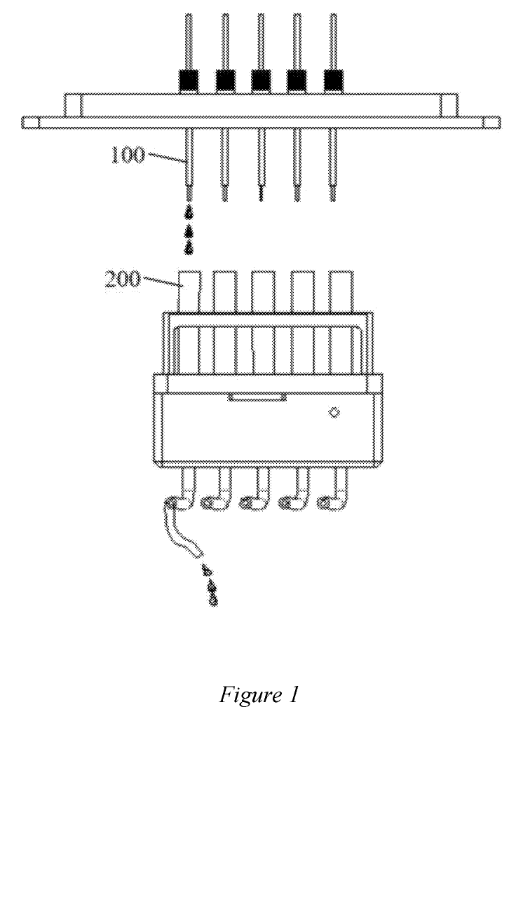

FIG. 2 shows a schematic perspective view of an apparatus for synthesis of a reagent and a packing according to a preferred embodiment of the disclosure;

FIG. 3 shows a schematic structural diagram of the apparatus for synthesis of a reagent and a packing shown in FIG. 2 when a reaction fluid mixture is separated from the reaction packing; and

FIG. 4 shows a schematic structural diagram of the apparatus for synthesis of a reagent and a packing shown in FIG. 2 when a part of a preliminary discharged liquid comes into contact and reacts with a reaction packing again.

List of reference signs: 100, liquid injection unit; 200, synthesis vessel; 210, packing; 220, body; 230, connecting pipe; 240, Luer connector; 300, liquid driving unit; 310, pump; 320, interface nozzle; 400, reagent liquid.

### DETAILED DESCRIPTION OF EMBODIMENTS

The disclosure is further described below with reference to the accompanying drawings and specific embodiments, such that those skilled in the art can better understand and implement the disclosure; however, the cited embodiments are not to be construed as limiting the disclosure.

### Embodiment 1

This embodiment provides a method for a synthesis reaction between a reagent and a packing, which is used for the synthesis of oligonucleotides, polypeptides, and the like. The method comprises the following steps.

In step S1, a reagent liquid comprising the reagent and a synthesis vessel loaded with a reaction packing are provided, and a first preset volume of the reagent liquid is introduced into the synthesis vessel.

Further, in this embodiment, the first volume V1 of the reagent liquid may be configured to be, for example, 150 μl, and may undergo a synthesis reaction in the synthesis vessel loaded with the packing.

In step S2, a part of a second preset volume of the reagent liquid flows through the reaction packing to obtain a primary reaction fluid; Further, in this embodiment, the reagent liquid inside the synthesis vessel flows out from the bottom of the synthesis vessel, such that a part of the reagent liquid is separated from the reaction packing as the primary reaction fluid.

Further, in this embodiment, step S2 further comprises:

defining the second volume of the primary reaction fluid as V2, and deriving a value of V2 by the following relationship:

V2 = X • V1/n, where n is an integer greater than 1, and 1 < X < n. On this basis, the second volume of the primary reaction fluid can be changed by adjusting the values of n and X according to actual needs.

Specifically, in this embodiment, n is set to 3, and X is preferably 2, such that the reaction process can take into account both reaction efficiency and synthesis effects. In different implementations, the specific settings of n and X can be adaptively adjusted according to actual reaction requirements and are not specifically limited in the disclosure. However, in order to significantly improve the purity of the product, X is preferably set between 1.5 and 2.5. On this basis, in this embodiment, V2 = 100 μl, and in this case, 50 μl of the reagent liquid remains in the synthesis vessel after step S2.

Further, in this embodiment, a discharge velocity Vx of the primary reaction fluid is 8-12 μl/s. It should be noted that, in this embodiment, the discharge velocity Vx is determined based on the variation law of product purity at different discharge velocities. Specifically, in this embodiment, the purity of a respective product synthesized under a plurality of discharge velocities varying at a uniform gradient is sequentially measured, and the optimal discharge velocity Vx is determined by comparison. Thereby, the product processing efficiency is relatively higher and the product purity is higher. For a conventional synthesis process, Vx is generally configured to be in the range of 5-100 μl/s.

Further, in order to ensure the sufficient contact between the reagent and the packing for a synthesis reaction, in this embodiment, a part of the reagent liquid flows through the reaction packing and remains still for a first time T1 to obtain the primary reaction fluid. In different embodiments, a value of the preset first time T1 may be adjusted accordingly for different chemical reactions according to experimental tests, and is not specifically limited in the disclosure.

In step S3, a part of a third preset volume of the primary reaction fluid flows through the reaction packing again in a reverse direction to obtain a secondary reaction fluid, wherein the other part of the primary reaction fluid that does not flow through the reaction packing in a reverse direction becomes a discharged liquid separated from the reaction packing, and a fourth volume of the discharged liquid is a difference between the second volume and the third volume.

Further, in this embodiment, step S3 further comprises: defining the third volume of the secondary reaction fluid as V3, and deriving a value of V3 by the following relationship: V3 = (X-1) • V1/n, defining the fourth volume of the discharged liquid separated from the reaction packing as V4, and V4 = V2 - V3 = V1/n. Thus, the purpose of performing the repeated reactions of the residual liquid simultaneously with the collection of the discharged liquid is achieved. Herein, the term “residual liquid” refers to a reagent liquid that has contacted and reacted with a reaction packing.

Specifically, in this embodiment, V3 and V4 are both 50 μl, and in this case, 50 μl of the discharged liquid is obtained after step S3, and the volume of the liquid in the synthesis vessel is 100 μl, which is specifically composed of 50 μl of the reagent liquid remaining in the synthesis vessel in step S2 and the secondary reaction fluid returned to the synthesis vessel in step S3.

Further, the part of the primary reaction fluid flows through the reaction packing again in the reverse direction at a backward velocity Vy of 6-10 μl/s. Likewise, for the conventional synthesis process, Vy is generally configured to be in the range of 5-100 μl/s.

Further, in step S3, the part of the primary reaction fluid flows through the reaction packing again in the reverse direction and remains still for a second time T2 to obtain a secondary reaction fluid, thereby increasing the contact time of the reagent in the part of the primary reaction fluid with the packing to achieve the purpose of improving the utilization rate of the reagent. In different implementations, the preset second time T2 may be adjusted accordingly based on an actual reagent type and environmental parameters, and is not specifically limited in the disclosure.

In step S4, after repeating steps S2-S3 multiple times, the reagent liquid remaining in the synthesis vessel is discharged.

According to the method of the disclosure, step S2 and step S3 may be regarded as a single cycle. A person skilled in the art can conceive that, after the cycle consisting of steps S2-S3 is repeated multiple times, a part of the reagent liquid may come into contact and react with the packing more than twice, depending on the set values of n and X. Therefore, the terms “primary reaction fluid” and “secondary reaction fluid” herein mean that a part of the reagent liquid comes into contact and reacts with the packing for the first and second times within a single cycle, and do not define the actual number of contacts and reactions across multiple cycles.

Further, in this embodiment, the number of repetitions of steps S2-S3 depends on the values of n and X, and is positively correlated with the value of n and negatively correlated with the value of X, and the specific parameter value thereof can be freely set according to actual processing requirements.

Specifically, since a monomer reagent used at a coupling stage of chemical synthesis is expensive, when the monomer reagent is used at the coupling stage, the number of repetitions (cycles) of steps S2 and S3 can be increased by appropriately increasing n and decreasing X, such that the utilization rate of the monomer reagent can be improved, and the experimental cost can be reduced. In contrast, reagents such as acetonitrile used during deprotection, oxidation, and capping stages are relatively inexpensive. Therefore, the number of repetitions (cycles) of steps S2-S3 can be reduced by appropriately reducing n and increasing X, or even no cycle is required.

Further, in this embodiment, in step S4, an upper limit may be set for the number of repetitions of steps S2-S3, and the number of repetitions of steps S2-S3 is at most an integer obtained by rounding down a calculation result of (n-X+1).

In this embodiment, upon repeating steps S2-S3 three times, the 50 μl of the reagent liquid remaining in the synthesis vessel is completely discharged to complete a full processing process of the synthesis reaction between the reagent and the packing. It can be seen that after repeating steps S2-S3 three times, the 50 μl of the reagent liquid remaining in the synthesis vessel is less than the second volume V2 (100 μl) in step 2. In this case, if steps 2 to 3 are to be performed again, the reagent liquid in the synthesis vessel will be completely emptied during step 2, and the packing will remain exposed to the air after step 3, which is undesirable as it is an ineffective cycle step. For this reason, as described above, an upper limit may be set for the number of repetitions of steps S2-S3. In this embodiment, since n is 3 and X is 2, the number of repetitions of steps S2-S3 is at most an integer obtained by rounding down a calculation result of (n-X+1), which is 3.

Further, the method for a synthesis reaction between a reagent and a packing disclosed in this embodiment is applicable to, for example, the synthesis of nucleic acid. Specifically, the method may be used at various stages of nucleic acid synthesis, such as coupling, deprotection, oxidation, and capping, and is particularly suitable for the coupling stage of nucleic acid synthesis. Different types of reagents are used respectively at the coupling, deprotection, oxidation, and capping stages of nucleic acid synthesis, given that the ATCG monomer reagent required for the coupling stage is expensive, and the reagents used at the deprotection, oxidation, and capping stages, such as acetonitrile, are relatively inexpensive.

Further, based on the process described above, this embodiment can improve the efficiency of nucleic acid synthesis, and significantly reduce reagent consumption and processing costs, which provides substantial practical significance for nucleic acid synthesis. Furthermore, the aforementioned process is applicable to synthesis reactions involving expensive chemical reagents. It can also be applied to stages such as deprotection, oxidation, and capping, thereby achieving the purposes of cost reduction and efficiency enhancement.

### Embodiment 2

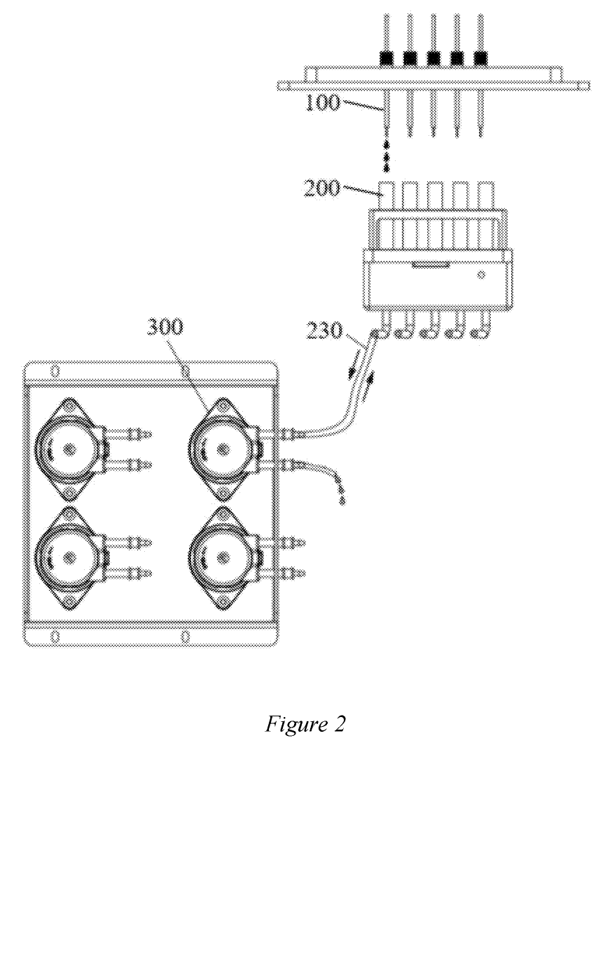

Referring to FIG. 2, this embodiment provides an apparatus for a synthesis reaction between a reagent and a packing. The apparatus comprises liquid injection units 100, synthesis vessels 200, and liquid driving units 300. The liquid injection units 100 are connected to a storage vessel storing a reagent liquid containing the reagent, configured to inject the reagent liquid 400 into the synthesis vessels 200, and may be in communication with a reagent container storing the reagent required for the synthesis reaction. The synthesis vessel 200 is loaded with a reaction packing 210 and provides a space for the synthesis reaction between the packing 210 and the reagent liquid 400, and the packing 210 is provided inside a body 220 of the synthesis vessel 200. The liquid driving units 300 are in communication with the synthesis vessels 200 and are configured to control the flow and a flow direction of the reagent liquid in the synthesis vessels 200 to enable the circulating reaction or the discharge of the liquid. The liquid driving units 300 each comprises a pump 310 and two interface nozzles 320, wherein the interface nozzles 320 are each provided on the pump 310, one of the interface nozzles 320 is in communication with an outlet end of the synthesis vessel 200, and the other of the interface nozzles 320 is in communication with a discharged liquid collection device (not shown).

The specific steps of performing a synthesis reaction between the reagent and the packing 210 using the aforementioned apparatus are as follows.

In step a, a first preset volume of the reagent liquid 400 is introduced into the synthesis vessel 200 by the liquid injection unit 100.

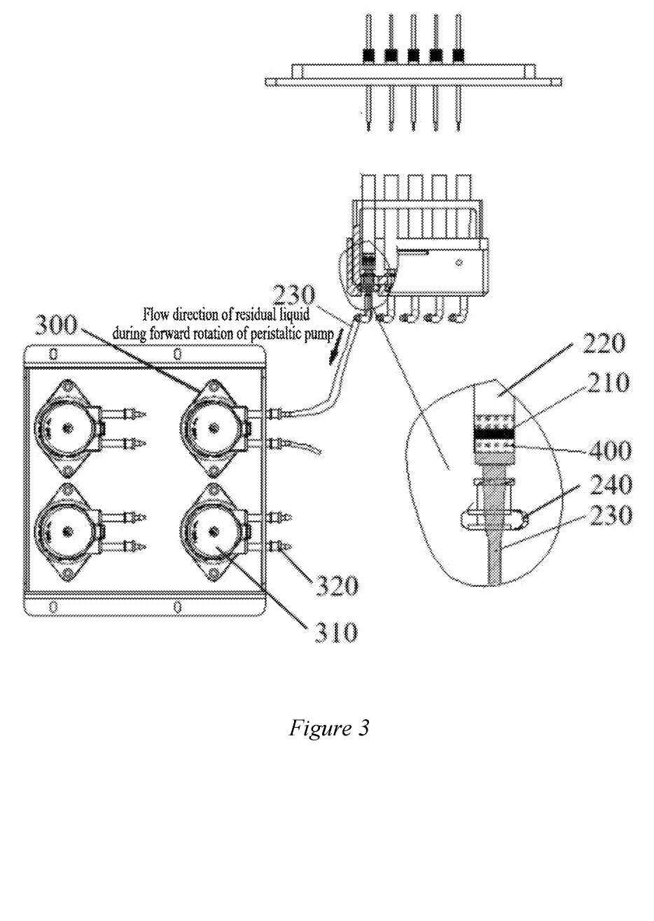

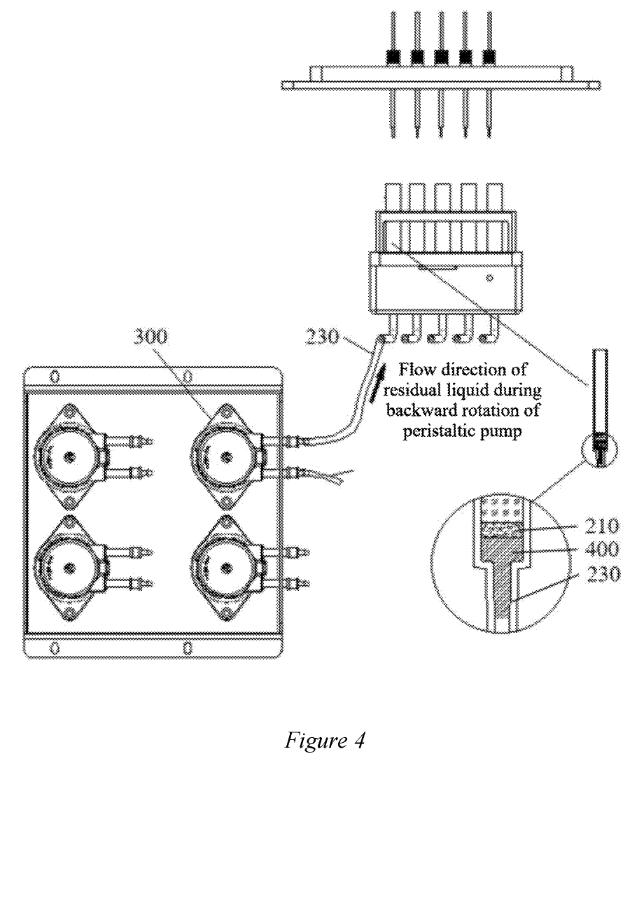

Further, referring to FIGS. 3 and 4, in this embodiment, the apparatus for synthesis of a reagent and a packing 210 may comprise a plurality of liquid injection units 100, a plurality of synthesis vessels 200, and a plurality of liquid driving units 300, wherein the plurality of liquid injection units 100 are arranged in a one-to-one correspondence with the plurality of synthesis vessels 200, and any of the synthesis vessels 200 is in communication with one of the liquid driving units 300. Thereby, a plurality of synthesis reactions can be conducted simultaneously to achieve a multi-fold increase in the synthesis efficiency of the reagent and the packing 210.

Further, in this embodiment, the synthesis vessel 200 is configured as a cylindrical structure, and in different implementations, the specific shape of the synthesis vessel may be adjusted according to actual application requirements. Furthermore, besides the liquid injection unit 100, other devices may be used in the present application to deliver reagents required for the synthesis reaction from the reagent container into the synthesis vessel 200, which is not specifically limited in the disclosure.

Specifically, in this embodiment, the first volume V1 of the reagent liquid 400 introduced into a corresponding synthesis vessel by any liquid injection unit 100 is configured to be, for example, 150 μl, that is, 150 μl of the reagent liquid 400 is fed into the corresponding synthesis vessels 200 via the plurality of liquid injection units 100.

In step b, a part of a preset second volume of the reagent liquid 400 flows through the reaction packing 210 by the liquid driving unit 300 to obtain a primary reaction fluid.

Further, in this embodiment, the body 220 of the synthesis vessel 200 is in communication with the interface nozzle 320 through a connecting pipe 230, and the body 220 is provided with a Luer connector 240 to connect the outlet end of the synthesis vessel 200 to the connecting pipe 230.

In other embodiments, in addition to the liquid driving unit 300, other types of pumps, double-acting cylinders, or the like may also be used to control the flow and the flow direction of the reagent liquid 400, which is not specifically limited in the disclosure.

In this embodiment, the volume of the primary reaction fluid is defined as V2, and a value of V2 is derived from the following relationship:

V2 = X • V1/n, where n is an integer greater than 1, and 1 < X < n. On this basis, the second volume of the primary reaction fluid can be changed by adjusting the values of n and X according to actual needs.

Specifically, in this embodiment, n is set to 3, and X is preferably 2, such that the reaction process can take into account both reaction efficiency and synthesis effects. In different implementations, the specific settings of n and X can be adaptively adjusted according to actual reaction requirements and are not specifically limited in the disclosure. However, in order to significantly improve the purity of the product, X is preferably set between 1.5 and 2.5. On this basis, in this embodiment, V2 = 100 μl, and in this case, 50 μl of the reagent liquid 400 remains in the synthesis vessel 200.

Further, in this embodiment, a discharge velocity Vx of the primary reaction fluid is 8-12 μl/s. It should be noted that, in this embodiment, the discharge velocity Vx is determined based on the variation law of product purity at different discharge velocities. Specifically, in this embodiment, the purity of a respective product synthesized under a plurality of discharge velocities varying at a uniform gradient is sequentially measured, and the optimal discharge velocity Vx is determined by comparison. Thereby, the product processing efficiency is relatively higher and the product purity is higher. For a conventional synthesis process, Vx is generally configured to be in the range of 5-100 μl/s.

Further, in order to ensure the sufficient contact between the reagent and the packing 210 for a synthesis reaction, in this embodiment, a part of the reagent liquid 400 flows through the reaction packing 210 and remains still for a first time T1 to obtain the primary reaction fluid. In different embodiments, a value of the preset first time T1 may be adjusted accordingly for different chemical reactions according to experimental tests, and is not specifically limited in the disclosure.

In step c, a part of a preset third volume of the primary reaction fluid flows through the reaction packing 210 in the synthesis vessel 200 again in a reverse direction by the liquid driving unit 300 to obtain a secondary reaction fluid, and the other part of the primary reaction fluid that does not flow through the reaction packing 210 in the reverse direction is discharged as a discharged liquid separated from the reaction packing 210 by the liquid driving unit 300, and a fourth volume of the discharged liquid is a difference between the second volume and the third volume.

Further, in this embodiment, step c further comprises: defining the third volume of the secondary reaction fluid as V3, and deriving a value of V3 by the following relationship: V3 = (X-1) • V1/n, defining the fourth volume of the discharged liquid separated from the reaction packing 210 as V4, and V4 = V2 - V3 = V1/n. Thus, the purpose of performing the repeated reactions of the residual liquid simultaneously with the collection of the product is achieved.

Specifically, in this embodiment, V3 and V4 are both 50 μl, and in this case, 50 μl of the discharged liquid is obtained after step c, and the volume of the liquid in the synthesis vessel 200 is 100 μl, which is specifically composed of 50 μl of the reagent liquid 400 remaining in the synthesis vessel 200 in step b and the secondary reaction fluid returned to the synthesis vessel 200 in step c.

Further, the part of the primary reaction fluid that flows through the reaction packing 210 in the synthesis vessel 200 again in the reverse direction by the liquid driving unit at a backward velocity Vy of 6-10 μl/s. Likewise, for the conventional synthesis process, Vy is generally configured to be in the range of 5-100 μl/s.

Further, in step c, the part of the primary reaction fluid flows through the reaction packing 210 again in the reverse direction and remains still for a time T2 to obtain a secondary reaction fluid, thereby increasing the contact time of the reagent in the part of the primary reaction fluid with the packing 210 to achieve the purpose of improving the utilization rate of the reagent. In different embodiments, the preset second time T2 is adjusted accordingly based on an actual reagent type and environmental parameters, and is not specifically limited in the disclosure.

In step d, after repeating steps b to c multiple times by the liquid driving unit 300, the reagent liquid 400 remaining in the synthesis vessel 200 is discharged.

Further, in this embodiment, the number of repetitions of steps b-c depends on the values of n and X, and is positively correlated with the value of n and negatively correlated with the value of X, and the parameter value thereof can be set according to actual processing requirements.

Specifically, since a monomer reagent used at a coupling stage is expensive, when the monomer reagent is used at the coupling stage, the number of repetitions (cycles) of steps b-c can be increased by appropriately increasing n and decreasing X, such that the utilization rate of the monomer reagent can be improved, and the experimental cost can be reduced. In contrast, reagents such as acetonitrile used during deprotection, oxidation, and capping stages are relatively inexpensive. Therefore, the number of repetitions (cycles) of steps b-c can be reduced by appropriately reducing n and increasing X, or even no cycle is required, and the liquid can be directly discharged by a peristaltic pump.

Further, in this embodiment, in step d, an upper limit may be set for the number of repetitions of steps b-c, and the number of repetitions of steps b-c is at most an integer obtained by rounding down a calculation result of (n-X+1).

In this embodiment, upon repeating steps b-c three times, the 50 μl of the reagent liquid 400 remaining in the synthesis vessel 200 is completely discharged to complete a full processing process of the synthesis reaction between the reagent and the packing 210.

Further, in this embodiment, the apparatus for synthesis of a reagent and a packing 210 may further comprise a control mechanism configured to control the operations of the liquid injection units 100 and the liquid driving units 300 in steps a to d. Specifically, the operation of introducing the reagent liquid into the synthesis vessel 200 by the liquid injection unit 100 in step a, the operation of allowing a part of the reagent liquid 400 to flow through the reaction packing 210 by the liquid driving unit 300 in the step b, the operation of allowing a part of the primary reaction fluid to flow through the reaction packing 210 again in a reverse direction by the liquid driving unit 300 in the step c, and the operations of repeating steps b-c multiple times and discharging the remaining reagent liquid 400 in the synthesis vessel 200 by the liquid driving unit 300 in step d are all performed under the control of the control mechanism.

Further, a program for carrying out the method for a synthesis reaction between the reagent and the packing 210 described above is stored in the control mechanism, and the liquid injection units 100, the synthesis vessels 200, and the liquid driving units 300 are each connected to the control mechanism. During actual production and processing, an operator can perform real-time regulation of the aforementioned structures by the control mechanism, thereby improving the operational flexibility of the apparatus, and parameters can be preset by the control mechanism, thereby increasing the degree of automation of the apparatus.

Further, the values of V1, n, and X can be set by a user by means of the control mechanism. The specific parameters that can be preset by the control mechanism comprise n and X that limit the number of cycles, the first velocity Vx at which the part of the reagent liquid flows through the reaction packing, the second velocity Vy at which the part of the primary reaction fluid flows through the reaction packing 210 again in the reverse direction, the first time T1 during which the part of the reagent liquid flows through the reaction packing 210 and remains still, the second time T2 during which the part of the primary reaction fluid flows through the reaction packing 210 again in the reverse direction and remains still, the first volume V1 of the reaction liquid introduced into the synthesis vessel 200, etc.

In summary, by increasing the contact between the reaction liquid and the packing 210, the disclosure ensures the full interaction between the two, enabling the complete conversion and processing of the residual liquid. This technique not only significantly enhances the reagent utilization efficiency, thereby achieving the purpose of cost reduction, but also effectively improves the purity of the final product.

Apparently, the above embodiments are merely examples provided for clear illustration and are not to be construed as limiting the implementations. For those of ordinary skill in the art, other different forms of variations or modifications may be made on the basis of the above description. It is neither necessary nor possible to provide an exhaustive list of all embodiments herein. Furthermore, obvious variations or modifications derived therefrom still fall within the scope of protection of the disclosure.

1. A method for a synthesis reaction between a reagent and a packing, comprising:
step S1, providing a reagent liquid comprising the reagent, and a synthesis vessel loaded with a reaction packing, and introducing a first preset volume of the reagent liquid into the synthesis vessel;
step S2, allowing a part of a second preset volume of the reagent liquid to flow through the reaction packing to obtain a primary reaction fluid;
step S3, allowing a part of a third preset volume of the primary reaction fluid to flow through the reaction packing again in a reverse direction to obtain a secondary reaction fluid, wherein the other part of the primary reaction fluid that does not flow through the reaction packing in the reverse direction is separated from the reaction packing as a discharged liquid, and a fourth volume of the discharged liquid is the difference between the second preset volume and the third preset volume; and
step S4, after repeating steps S2-S3 multiple times, discharging the reagent liquid remaining in the synthesis vessel.

2. The method for a synthesis reaction between a reagent and a packing according to claim 1, wherein
the first preset volume of the reaction liquid introduced into the synthesis vessel in step S1 is defined as V1; and
step S2 further comprises: defining the second preset volume of the primary reaction fluid as V2, and deriving a value of V2 by a relationship of:
V2 = X • V1/n, where n is an integer greater than 1, and 1 < X < n.

3. The method for a synthesis reaction between a reagent and a packing according to claim 2, wherein
step S3 further comprises:
defining the third preset volume of the secondary reaction fluid as V3, and deriving a value of V3 by a relationship of:
V3 = (X-1) • V1/n; and
defining the fourth volume of the discharged liquid separated from the reaction packing as V4, and V4 = V2 - V3 = V1/n.

4. The method for a synthesis reaction between a reagent and a packing according to claim 3, wherein
in step S4, the number of repetitions of steps S2 to S3 depends on the values of n and X, and is positively correlated with the value of n and negatively correlated with the value of X.

5. The method for a synthesis reaction between a reagent and a packing according to claim 3, wherein in step S4, the maximum number of repetitions of steps S2 to S3 is an integer obtained by rounding down a calculation result of (n-X+1).

6. The method for a synthesis reaction between a reagent and a packing according to claim 1, wherein in step S2, the part of the reagent liquid flows through the reaction packing at a first velocity Vx in a range of 5-100 μl/s; and in step S3, the part of the primary reaction fluid flows through the reaction packing again in the reverse direction at a second velocity Vy in a range of 5-100 μl/s.

7. The method for a synthesis reaction between a reagent and a packing according to claim 1, wherein in step S2, the part of the reagent liquid flows through the reaction packing and remains still for a first time T1 to obtain the primary reaction fluid; and in step S3, the part of the primary reaction fluid flows through the reaction packing again in the reverse direction and remains still for a second time T2 to obtain the secondary reaction fluid.

8. An apparatus for synthesis of a reagent and a packing, comprising a liquid injection unit, a synthesis vessel, and a liquid driving unit, wherein
the liquid injection unit is connected to a storage vessel storing a reagent liquid containing the reagent, and the synthesis vessel is loaded with a reaction packing, and the liquid injection unit is configured to introduce the reagent liquid into the synthesis vessel; and
the liquid driving unit is in communication with the synthesis vessel and is configured to control the flow and a flow direction of the reagent liquid in the synthesis vessel; and
the apparatus for synthesis of a reagent and a packing performs the synthesis of the reagent with the packing by
step a, introducing a first preset volume of the reagent liquid into the synthesis vessel by the liquid injection unit;
step b, allowing a part of a second preset volume of the reagent liquid to flow through the reaction packing by the liquid driving unit to obtain a primary reaction fluid;
step c, allowing a part of a third preset volume of the primary reaction fluid to flow through the reaction packing again in a reverse direction by the liquid driving unit to obtain a secondary reaction fluid, wherein the other part of the primary reaction fluid that does not flow through the reaction packing in the reverse direction is separable from the reaction packing as a discharged liquid, and a fourth volume of the discharged liquid is the difference between the second preset volume and the third preset volume; and
step d, after repeating steps b and c multiple times by the liquid driving unit, discharging the reagent liquid remaining in the synthesis vessel.

9. The apparatus for synthesis of a reagent and a packing according to claim 8, comprising a plurality of liquid injection units, a plurality of synthesis vessels, and a plurality of liquid driving units, wherein the plurality of liquid injection units are arranged in a one-to-one correspondence with the plurality of synthesis vessels, and any of the synthesis vessels is in communication with one of the liquid driving units.

10. The apparatus for synthesis of a reagent and a packing according to claim 8, wherein the liquid driving unit comprises a pump and two interface nozzles each provided on the pump, wherein one of the interface nozzles is in communication with the synthesis vessel, and the other of the interface nozzles is in communication with a discharged liquid collection device.

11. The apparatus for synthesis of a reagent and a packing according to claim 8, further comprising a control mechanism configured to control the operations of the liquid injection units and the liquid driving units in steps a to d.

12. The apparatus for synthesis of a reagent and a packing according to claim 11, wherein
the first preset volume of the reaction liquid introduced into the synthesis vessel in step a is defined as V1;
step b further comprises: defining the second preset volume of the primary reaction fluid as V2, and deriving a value of V2 by a relationship of: V2 = X • V1/n, where n is an integer greater than 1, and 1 < X < n;
step c further comprises: defining the third preset volume of the secondary reaction fluid as V3, and deriving the value of V3 by a relationship of: V3 = (X-1) • V1/n, defining the fourth volume of the discharged liquid separated from the reaction packing as V4, and V4 = V2 - V3 = V1/n; and
the values of V1, n, and X are set by a user by means of the control mechanism.
